(19) United States
(12) Patent Application Publication
(10) Pub. No.: US 2026/0067702 A1
(43) Pub. Date: Mar. 5, 2026

(54) METHOD FOR PERFORMING COEXISTENCE MANAGEMENT WITH RESPECT TO NON-ALIGNED CHANNEL IN WIRELESS COMMUNICATION SYSTEM, AND ASSOCIATED APPARATUS

(71) Applicant: MEDIATEK INC., Hsin-Chu (TW)

(72) Inventors: Ching-Wen Hsiao, Hsinchu City (TW); Cheng-Yi Chang, Hsinchu City (TW); Ting-Che Tseng, Hsinchu City (TW)

(73) Assignee: MEDIATEK INC., Hsin-Chu (TW)

(21) Appl. No.: 18/817,172

(22) Filed: Aug. 27, 2024

(51) Int. Cl. H04W 16/14; H04L 5/00; H04W 28/26

(52) U.S. Cl. CPC H04W 16/14; H04L 5/0046; H04W 28/26

(57) ABSTRACT

A method for performing coexistence management with respect to a non-aligned channel in a wireless communication system and associated apparatus are provided, where a target device using a target channel is wirelessly linking to a wireless transceiver device, and a difference between a minimum of a first frequency range of the non-aligned channel and a minimum of a second frequency range of the target channel is not a multiple of twenty megahertz (20 MHz). The method may include: transmitting dual control frames of a same subtype to reserve airtime in the target channel as well as the non-aligned channel, for data transmission corresponding to the target channel; or transmitting a physical layer (PHY) protocol data unit (PPDU) on the target channel, with at least one part of the PPDU being frequency-shifted for alignment to the non-aligned channel in order to spoof another device that is using the non-aligned channel.

### BACKGROUND

The present invention is related to communication control, and more particularly, to a method for performing coexistence management with respect to a non-aligned channel in a wireless communication system, and associated apparatus such as a wireless transceiver device (e.g., an access point (AP) device or a station (STA) device) in the wireless communication system.

According to the related art, wireless devices may be designed to operate in one or more predetermined radio bands. In the USA, some Unlicensed National Information Infrastructure (U-NII, or UNII) radio bands such as the UNII-2C, UNII-3 and UNII-4 bands may be released for usage of the wireless devices. The spectrum is contiguous. However, the existing Wi-Fi channelization may have a five megahertz (MHz) channel offset between neighbor channels respectively belonging to the UNII-2C band and the UNII-3 band, such as the uppermost channel in the UNII-2C band and the lowermost channel in the UNII-3 band in any of multiple channel bandwidth configurations respectively corresponding to multiple predetermined bandwidths. How to use continuous bandwidth (BW) across the UNII-2C band and the UNII-3 band and coexist with existing Wi-Fi device has become an importance topic. It seems that there is no proper suggestion in the related art. Thus, a novel method and associated architecture are needed for solving the problem without introducing any side effect or in a way that is less likely to introduce a side effect.

### SUMMARY

It is an objective of the present invention to provide a method for performing coexistence management with respect to a non-aligned channel in a wireless communication system, and associated apparatus such as a wireless transceiver device (e.g., an AP device or a non-access-point (non-AP) STA device) in the wireless communication system, in order to solve the above-mentioned problem.

At least one embodiment of the present invention provides a method for performing coexistence management with respect to a non-aligned channel in a wireless communication system, where a target device using a target channel is wirelessly linking to a wireless transceiver device, and a difference between a minimum of a first frequency range of the non-aligned channel and a minimum of a second frequency range of the target channel is not a multiple of twenty megahertz (20 MHz). For example, the method may comprise: transmitting, by the wireless transceiver device, dual control frames of a same subtype to reserve airtime in the target channel as well as the non-aligned channel, for data transmission corresponding to the target channel; wherein one of the dual control frames is sent via the target channel while the other of the dual control frames is sent via the non-aligned channel. According to some embodiments, the dual control frames may comprise dual request to send (RTS) frames concurrently transmitted by the wireless transceiver device, dual clear to send (CTS) frames concurrently transmitted by the wireless transceiver device, dual RTS frames sequentially transmitted by the wireless transceiver device, or dual CTS frames sequentially transmitted by the wireless transceiver device.

At least one embodiment of the present invention provides a wireless transceiver device for performing coexistence management with respect to a non-aligned channel in a wireless communication system such as that mentioned above, where the wireless transceiver device is one of multiple devices within the wireless communication system. The wireless transceiver device may comprise a processing circuit that is arranged to control operations of the wireless transceiver device. The wireless transceiver device may further comprise at least one communication control circuit that is coupled to the processing circuit and arranged to perform communication control, wherein the aforementioned at least one communication control circuit is arranged to perform wireless communication operations with at least one other device among the multiple devices for the wireless transceiver device. In addition, a target device using a target channel among the aforementioned at least one other device is wirelessly linking to the wireless transceiver device, and a difference between a minimum of a first frequency range of the non-aligned channel and a minimum of a second frequency range of the target channel is not a multiple of 20 MHz. For example, the wireless transceiver device is arranged to transmit dual control frames of a same subtype to reserve airtime in the target channel as well as the non-aligned channel, for data transmission corresponding to the target channel; wherein one of the dual control frames is sent via the target channel while the other of the dual control frames is sent via the non-aligned channel.

At least one embodiment of the present invention provides a method for performing coexistence management with respect to a non-aligned channel in a wireless communication system, where a target device using a target channel is wirelessly linking to a wireless transceiver device, and a difference between a minimum of a first frequency range of the non-aligned channel and a minimum of a second frequency range of the target channel is not a multiple of 20 MHz. For example, the method may comprise: transmitting, by the wireless transceiver device, a physical layer (PHY) protocol data unit (PPDU) on the target channel, with at least one part of the PPDU being frequency-shifted for alignment to the non-aligned channel in order to spoof another device that is using the non-aligned channel; wherein a remaining part of the PPDU is sent via the target channel while the aforementioned at least one part of the PPDU is sent via the non-aligned channel. According to an embodiment, the remaining part and the aforementioned at least one part of the PPDU may comprise a normal preamble corresponding to the target channel and an additional preamble at least corresponding to the non-aligned channel with a frequency offset for the alignment to the non-aligned channel, respectively, or multiple first basic building blocks of a preamble within the PPDU and multiple second basic building blocks of the preamble with a frequency offset for the alignment to the non-aligned channel, respectively, or multiple first duplicated payloads among multiple duplicated payloads (e.g., the multiple duplicated payloads of data that are carried by the PPDU such as a duplicate PPDU in multiple sub-bandwidths of the total channel bandwidth of the union of the target channel and the non-aligned channel) and multiple second duplicated payloads among the multiple duplicated payloads with a frequency offset for the alignment to the non-aligned channel, respectively.

At least one embodiment of the present invention provides a wireless transceiver device for performing coexistence management with respect to a non-aligned channel in a wireless communication system such as that mentioned above, where the wireless transceiver device is one of multiple devices within the wireless communication system. The wireless transceiver device may comprise a processing circuit that is arranged to control operations of the wireless transceiver device. The wireless transceiver device may further comprise at least one communication control circuit that is coupled to the processing circuit and arranged to perform communication control, wherein the aforementioned at least one communication control circuit is arranged to perform wireless communication operations with at least one other device among the multiple devices for the wireless transceiver device. In addition, a target device using a target channel among the aforementioned at least one other device is wirelessly linking to the wireless transceiver device, and a difference between a minimum of a first frequency range of the non-aligned channel and a minimum of a second frequency range of the target channel is not a multiple of 20 MHz. For example, the wireless transceiver device is arranged to transmit a physical layer (PHY) protocol data unit (PPDU) on the target channel, with at least one part of the PPDU being frequency-shifted for alignment to the non-aligned channel in order to spoof another device that is using the non-aligned channel; wherein a remaining part of the PPDU is sent via the target channel while the aforementioned at least one part of the PPDU is sent via the non-aligned channel.

It is an advantage of the present invention that, through proper design, the method of the present invention, as well as the associated apparatus such as the wireless transceiver device, can resolve the 320 MHz bandwidth (or “BW320”) coexistence issue of the 5 gigahertz (GHz) radio frequency (RF) band, and more particularly, prevent failure of the data reception of the target device using the target channel (e.g., Channel B) due to coexisting operations of any non-target device using the non-aligned channel (e.g., Channel A). For example, when sending the RTS frame to the target device using Channel B and waiting for the corresponding CTS frame, the wireless transceiver device operating according to the method can effectively make the non-target device using Channel A be notified correctly, and therefore can prevent frequent collision in the case of the coexistence of the target device using Channel B and the non-target device using Channel A. In addition, the method of the present invention and the associated apparatus such as the wireless transceiver device can solve the 5 GHz BW320 coexistence issue without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates a wider bandwidth transmission control scheme of a method for performing coexistence management with respect to a non-aligned channel in a wireless communication system according to an embodiment of the present invention.

FIG. 3 illustrates, in the lower half part thereof, a first procedure modification control scheme of the method according to an embodiment of the present invention, where a non-modification control scheme may be illustrated in the upper half part of FIG. 3 for better comprehension.

FIG. 4 illustrates, in multiple sub-diagrams (a) and (b) thereof, multiple procedure modification control schemes of the method according to some embodiments of the present invention.

FIG. 5 illustrates, in multiple sub-diagrams (a) and (b) thereof, multiple PPDU modification control schemes of the method according to some embodiments of the present invention.

FIG. 6 illustrates another PPDU modification control scheme of the method according to an embodiment of the present invention.

FIG. 7 illustrates another PPDU modification control scheme of the method according to an embodiment of the present invention.

FIG. 8 illustrates another PPDU modification control scheme of the method according to an embodiment of the present invention.

FIG. 9 illustrates another PPDU modification control scheme of the method according to an embodiment of the present invention.

FIG. 10 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

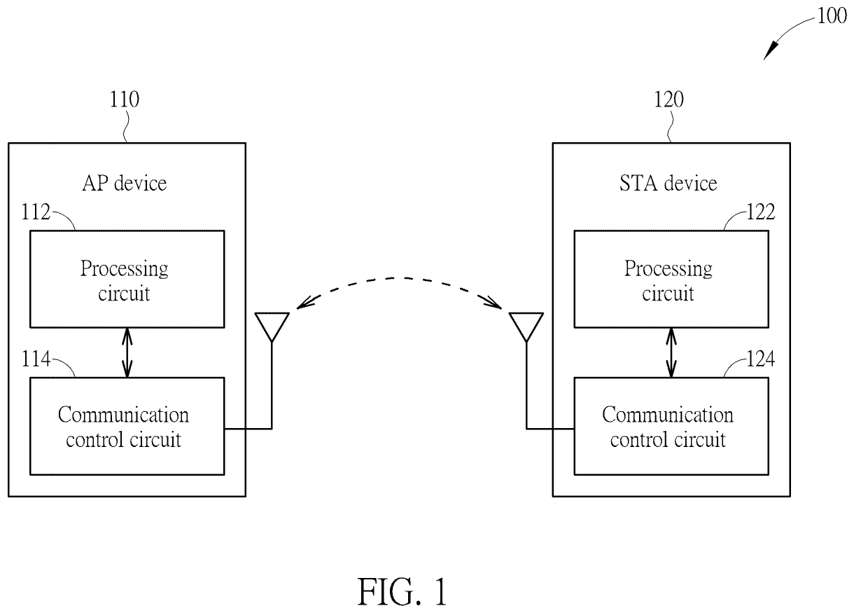

FIG. 1 is a diagram of a wireless communication system 100 according to an embodiment of the present invention. For better comprehension, the wireless communication system 100, as well as any wireless transceiver device #n among multiple wireless transceiver devices #1, . . . and #N therein, may be compatible or backward-compatible to one or more versions of the Institute of Electrical and Electronics Engineers (IEEE) 802.11 standards, but the present invention is not limited thereto. Regarding the multiple wireless transceiver devices #1, . . . and #N within the wireless communication system 100, a wireless transceiver device among them may be implemented as the AP device 110, and another transceiver device among them may be implemented as the STA device 120 such as the non-AP STA device 120, but the present invention is not limited thereto. For example, two or more wireless transceiver devices among the multiple wireless transceiver devices #1, . . . and #N may be implemented as multiple AP devices {110}. For another example, two or more wireless transceiver devices among the multiple wireless transceiver devices #1, . . . and #N may be implemented as multiple STA devices {120} such as multiple non-AP STA devices {120}. In some examples, two or more wireless transceiver devices among the multiple wireless transceiver devices #1, . . . and #N may be implemented as multiple AP devices {110}, and two or more other wireless transceiver devices among the multiple wireless transceiver devices #1, . . . and #N may be implemented as multiple STA devices {120} such as multiple non-AP STA devices {120}.

As shown in FIG. 1, the AP device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the STA device 120 may comprise a processing circuit 122, at least one communication control circuit (e.g., one or more communication control circuits), which may be collectively referred to as the communication control circuit 124, and at least one antenna (e.g., one or more antennas) of the communication control circuit 124. In the architecture shown in FIG. 1, the processing circuit 112 can be arranged to control operations of the AP device 110, and the communication control circuit 114 can be arranged to perform communication control, and more particularly, perform wireless communication operations with the network (or at least one other device therein such as the STA device 120) for the AP device 110. In addition, the processing circuit 122 can be arranged to control operations of the STA device 120, and the communication control circuit 124 can be arranged to perform communication control, and more particularly, perform wireless communication operations with the network (or at least one other device therein such as the AP device 110) for the STA device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the STA device 120 may include, but are not limited to: a multifunctional mobile phone, a laptop computer, an all-in-one computer and a wearable device.

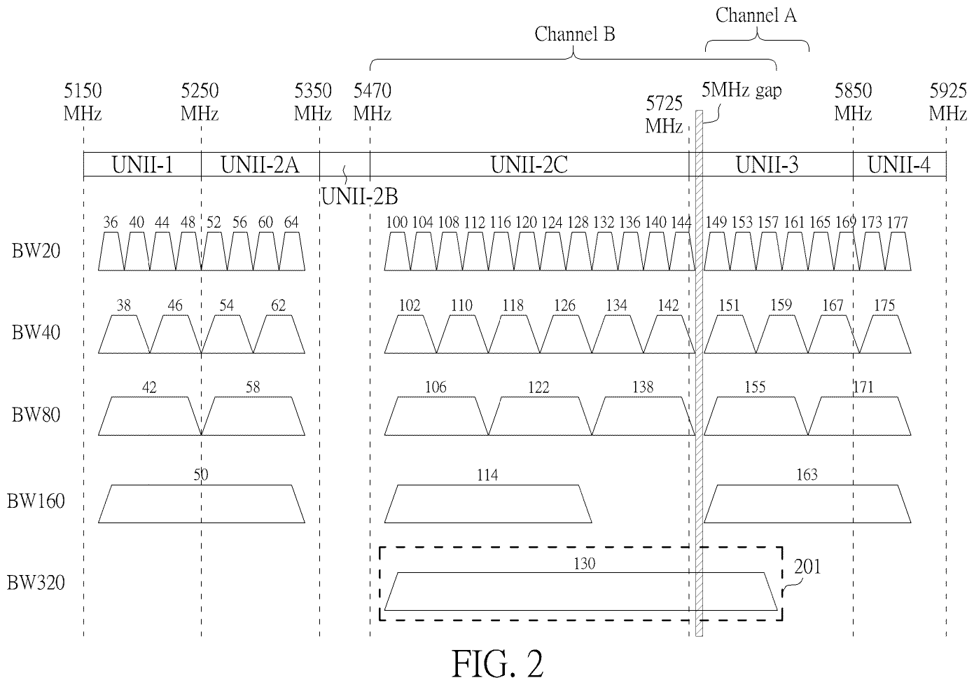

FIG. 2 illustrates a wider bandwidth transmission control scheme of a method for performing coexistence management with respect to a non-aligned channel in a wireless communication system (e.g., the wireless communication system 100 shown in FIG. 1) according to an embodiment of the present invention. For better comprehension, assume that one or more functions of the wireless communication system 100 may be temporarily disabled to allow the AP device 110 and the STA device 120 to operate according to a non-wider bandwidth transmission control scheme involved with the multiple predetermined bandwidths such as the 20 MHz bandwidth (or “BW20”), the 40 MHz bandwidth (or “BW40”), the 80 MHz bandwidth (or “BW80”) and the 160 MHz bandwidth (or “BW160”), where the channels respectively corresponding to the BW20, the BW40, etc. may be illustrated as the rows of channels on which the channel numbers {{36, 40, . . . }, {38, 46, . . . }, . . . } are labeled thereon, and may be referred to as the channels {{CH36, CH40, . . . }, {CH38, CH46, . . . }, . . . }, but the present invention is not limited thereto. Based on the non-wider bandwidth transmission control scheme, there is the five megahertz (5 MHz) channel offset between neighbor channels (e.g., any set of neighbor channels among the sets of neighbor channels {{CH144, CH149}, {CH142, CH151}, {CH138, CH155}}) respectively belonging to the UNII-2C band and the UNII-3 band (labeled “5 MHz gap” for brevity).

The wireless communication system 100 (or the AP device 110 and the STA device 120 therein) may operate in a target channel B (labeled “Channel B” for brevity) according to one or more control schemes (e.g., the wider bandwidth transmission control scheme) of the method to achieve a better overall performance, without being hindered by another device that is using the non-aligned channel A (labeled “Channel A” for brevity) in the UNII-3 band. For example, among multiple wireless transceiver devices #1, . . . and #N of the wireless communication system 100, the wireless transceiver device #n such as the AP device 110 and a target device #n′ such as the STA device 120 may use the target channel B such as at least one enlarged channel (e.g., one or more enlarged channels), which may be collectively referred to as the enlarged channel 201, to communicate with each other, and more particularly, perform data transmission/reception via the enlarged channel 201 (e.g., the channel CH130) corresponding to the 320 MHz bandwidth (or “BW320”) in order to increase the throughput with the aid of the wider bandwidth such as the BW320. In addition, the target device #n′ such as the STA device 120 may be wirelessly linking to the wireless transceiver device #n such as the AP device 110, and they may be arranged to use the target channel B such as the enlarged channel 201 across the UNII-2C band and the UNII-3 band as shown in FIG. 2. The difference between the minimum of a first frequency range of the non-aligned channel A (e.g., the channel CH155) and the minimum of a second frequency range of the target channel B (e.g., the channel CH130) is not a multiple of 20 MHz, which means the devices using the channels in the UNII-3 band would be unaware of existing communication operation(s) of the AP device 110 and the STA device 120 if the AP device 110 were merely using a legacy procedure or a legacy PPDU format in the target channel B. The wireless transceiver device #n (e.g., the AP device 110) operating according to the one or more control schemes of the method may utilize a modified procedure in the target channel B to reserve the airtime of the non-aligned channel A or utilize a modified PPDU format in the target channel B to spoof the other device that is using the non-aligned channel A, to perform the data transmission/reception without being hindered by the other device.

For example, in a first case of utilizing the modified procedure, the associated operations may comprise:
(1) the wireless transceiver device #n such as the AP device 110 may transmit dual control frames of the same subtype to reserve airtime in the target channel B as well as the non-aligned channel A, for data transmission corresponding to the target channel B, where one of the dual control frames is sent via the target channel B while the other of the dual control frames is sent via the non-aligned channel A; and
(2) the wireless transceiver device #n such as the AP device 110 may perform the data transmission corresponding to the target channel B in order to send data via the target channel B, and wait for an acknowledgment (ACK) from the target device #n′, such as the ACK that is sent by the target device #n′ in response to the reception of the data;
where the wireless transceiver device #n may carry at least one medium access control (MAC) address among a first MAC address of the wireless transceiver device #n (e.g., the AP device 110) and a second MAC address of the target device #n′ (e.g., the STA device 120) in each control frame among the dual control frames, but the present invention is not limited thereto. In a second case of utilizing the modified PPDU format, the associated operations may comprise:
(1) the wireless transceiver device #n such as the AP device 110 may transmit a PPDU on the target channel B, with at least one part of the PPDU being frequency-shifted for alignment to the non-aligned channel A in order to spoof the other device that is using the non-aligned channel A, where a remaining part of the PPDU is sent via the target channel B while the aforementioned at least one part of the PPDU is sent via the non-aligned channel A; and
(2) the wireless transceiver device #n such as the AP device 110 may wait for an ACK from the target device #n′, such as the ACK that is sent by the target device #n′ in response to the reception of the data;
where the wireless transceiver device #n may prepare the aforementioned at least one part of the PPDU with a frequency offset for the alignment to the non-aligned channel A. No matter whether it is the first case or the second case, the wireless transceiver device #n (e.g., the AP device 110) and the target device #n′ (e.g., the STA device 120) that are operating according to the one or more control schemes of the method can perform the data transmission/reception in the target channel B without being hindered by the other device that is using the non-aligned channel A.

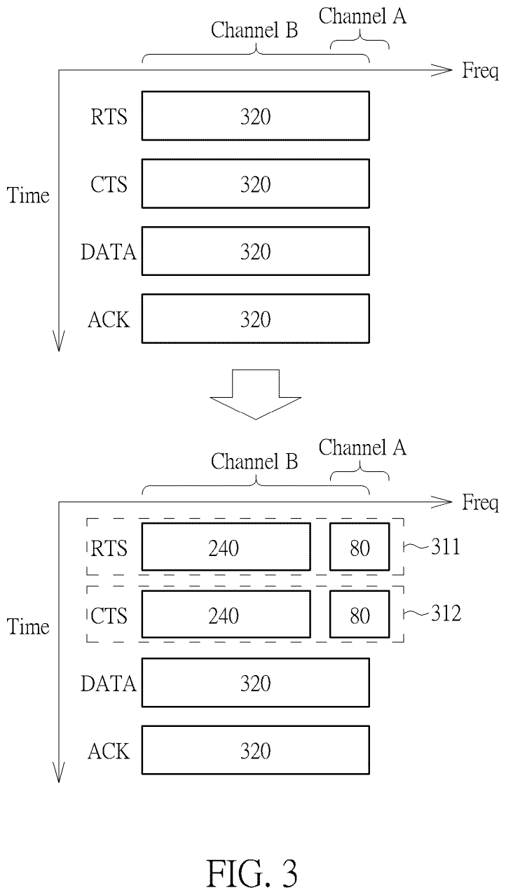

FIG. 3 illustrates, in the lower half part thereof, a first procedure modification control scheme of the method according to an embodiment of the present invention, where a non-modification control scheme regarding the legacy procedure may be illustrated in the upper half part of FIG. 3 for better comprehension. The horizontal axis may represent frequency (labeled “Freq” for brevity), and the vertical axis may represent time. Assume that one or more functions of the wireless communication system 100 may be temporarily disabled to allow the AP device 110 and the STA device 120 to operate according to the non-modification control scheme regarding the legacy procedure, but the present invention is not limited thereto. Based on this non-modification control scheme, the wireless transceiver device #n such as the AP device 110 may be merely using the legacy procedure in the target channel B, and therefore the other device (e.g., a Wi-Fi device) that is using the non-aligned channel A cannot correctly receive any PPDU in the target channel B due to the 5 MHz offset. The RTS/CTS protection cannot take effect on the other device that is using the non-aligned channel A. As a result, collision occurs frequently while both of the other device that is using the non-aligned channel A and the AP device 110 and the STA device 120 that are using the target channel B exist.

The wireless communication system 100 (or the AP device 110 and the STA device 120 therein) may operate according to the first procedure modification control scheme to achieve the better overall performance, without being hindered by the other device that is using the non-aligned channel A. In the first case of utilizing the modified procedure, the dual control frames may comprise dual RTS frames 311 concurrently transmitted by the wireless transceiver device #n (e.g., the AP device 110), such as a first RTS frame in a lower 240 MHz bandwidth (or “BW240”) of the target channel B and a second RTS frame in the whole channel bandwidth (e.g., the BW80) of the non-aligned channel A (respectively labeled “240” and “80” for better comprehension). More particularly, the wireless transceiver device #n (e.g., the AP device 110) may concurrently transmit the dual RTS frames 311 to reserve the airtime in the target channel B as well as the non-aligned channel A, and wait for a set of CTS frames corresponding to the dual RTS frames 311, such as the set of CTS frames 312 from the target device #n′ (e.g., the STA device 120), for performing the data transmission corresponding to the target channel B afterward, in order to send the data (or “DATA”) via the target channel B and wait for the ACK that is sent by the target device #n′ (e.g., the STA device 120) in response to the reception of the data, where both of the data (or “DATA”) and the ACK may be sent via the whole channel bandwidth (e.g., the BW320) of the target channel B (labeled “320” for brevity).

In the embodiment shown in FIG. 3, the wireless communication system 100 (or the AP device 110 and the STA device 120) can use the non-contiguous RTS/CTS frames {311, 312} such as the first and the second RTS frames 311 from the wireless transceiver device #n and the set of CTS frames 312 from the target device #n′ to reserve the airtime both in the non-aligned channel A and the target channel B, but the present invention is not limited thereto. According to some embodiments, it is unnecessary to transmit the dual RTS frames 311, and therefore the dual RTS frames 311 may be removed from FIG. 3 in these embodiments. For example, in the first case of utilizing the modified procedure, the dual control frames may comprise dual CTS frames 312 concurrently transmitted by the wireless transceiver device #n (e.g., the AP device 110), such as a first CTS frame in the lower BW240 of the target channel B and a second CTS frame in the whole channel bandwidth (e.g., the BW80) of the non-aligned channel A (respectively labeled “240” and “80” for better comprehension). Thus, the wireless communication system 100 (or the AP device 110 and the STA device 120) can use the non-contiguous CTS frames 312 such as the first and the second CTS frames 312 to reserve the airtime both in the non-aligned channel A and the target channel B. For brevity, similar descriptions for these embodiments are not repeated in detail here.

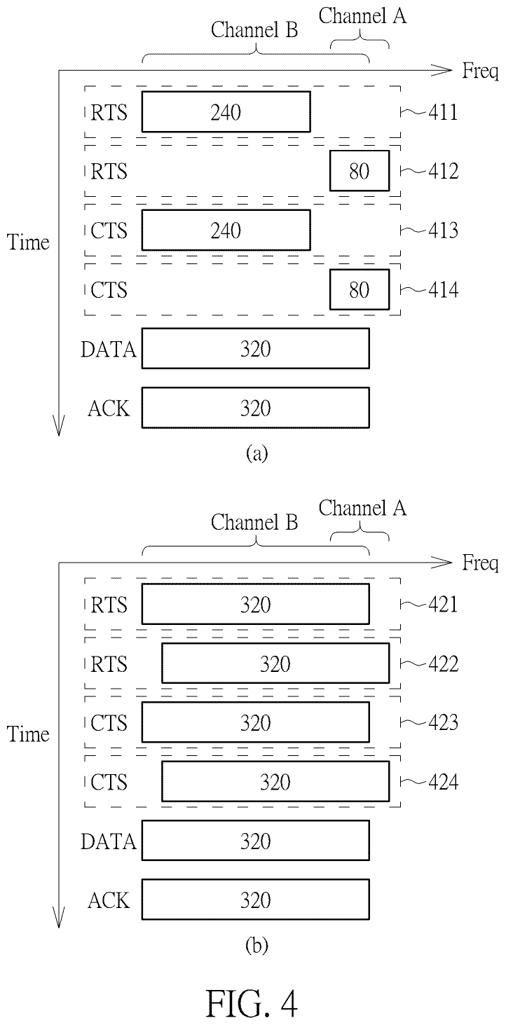

FIG. 4 illustrates, in multiple sub-diagrams (a) and (b) thereof, multiple procedure modification control schemes of the method according to some embodiments of the present invention. The horizontal axis may represent frequency (labeled “Freq” for brevity), and the vertical axis may represent time. The wireless communication system 100 (or the AP device 110 and the STA device 120 therein) may operate according to any procedure modification control scheme among the multiple procedure modification control schemes shown in the sub-diagrams (a) and (b) to achieve the better overall performance, without being hindered by the other device that is using the non-aligned channel A. Regarding the sub-diagram (a), in the first case of utilizing the modified procedure, the dual control frames may comprise dual RTS frames 411 and 412 sequentially transmitted by the wireless transceiver device #n (e.g., the AP device 110), such as a first RTS frame in the lower BW240 of the target channel B and a second RTS frame in the whole channel bandwidth (e.g., the BW80) of the non-aligned channel A (respectively labeled “240” and “80” for better comprehension). More particularly, the wireless transceiver device #n (e.g., the AP device 110) may sequentially transmit the dual RTS frames 411 and 412 to reserve the airtime in the target channel B as well as the non-aligned channel A, and wait for a set of CTS frames corresponding to the dual RTS frames 411 and 412, such as the set of CTS frames 413 and 414 from the target device #n′ (e.g., the STA device 120), for performing the data transmission corresponding to the target channel B afterward, in order to send the data (or “DATA”) via the target channel B and wait for the ACK that is sent by the target device #n′ (e.g., the STA device 120) in response to the reception of the data, where both of the data (or “DATA”) and the ACK may be sent via the whole channel bandwidth (e.g., the BW320) of the target channel B (labeled “320” for brevity).

Regarding the sub-diagram (b), in the first case of utilizing the modified procedure, the dual control frames may comprise dual RTS frames 421 and 422 sequentially transmitted by the wireless transceiver device #n (e.g., the AP device 110), such as a first RTS frame in the whole channel bandwidth (e.g., the BW320) of the target channel B and a second RTS frame in a frequency-shifted channel bandwidth (e.g., another BW320) extending from the whole channel bandwidth (e.g., the BW80) of the non-aligned channel A toward the minimum of the second frequency range of the target channel B (respectively labeled “320” and “320” for better comprehension). More particularly, the wireless transceiver device #n (e.g., the AP device 110) may sequentially transmit the dual RTS frames 421 and 422 to reserve the airtime in the target channel B as well as the non-aligned channel A, and wait for a set of CTS frames corresponding to the dual RTS frames 421 and 422, such as the set of CTS frames 423 and 424 from the target device #n′ (e.g., the STA device 120), for performing the data transmission corresponding to the target channel B afterward, in order to send the data (or “DATA”) via the target channel B and wait for the ACK that is sent by the target device #n′ (e.g., the STA device 120) in response to the reception of the data, where both of the data (or “DATA”) and the ACK may be sent via the whole channel bandwidth (e.g., the BW320) of the target channel B (labeled “320” for brevity).

In the embodiment shown in FIG. 4, the wireless communication system 100 (or the AP device 110 and the STA device 120) can use the dual RTS frames 411 and 412 (or the dual RTS frames 421 and 422) as well as the set of CTS frames 413 and 414 (or the set of CTS frames 423 and 424) to protect the airtime in the target channel B as well as the non-aligned channel A sequentially, where one of the dual RTS frames 411 and 412 (or the dual RTS frames 421 and 422) is for the non-aligned channel A, and the other one of the dual RTS frames 411 and 412 (or the dual RTS frames 421 and 422) is for the target channel B, but the present invention is not limited thereto. According to some embodiments, the respective bandwidths of the dual RTS frames 411 and 412 (or the dual RTS frames 421 and 422) as well as the respective bandwidths of the set of CTS frames 413 and 414 (or the set of CTS frames 423 and 424) may vary.

In addition, the wireless transceiver device #n (e.g., the AP device 110) of the embodiment shown in FIG. 4 may transmit both of the dual RTS frames 411 and 412 (or the dual RTS frames 421 and 422) first, and then wait for the set of CTS frames 413 and 414 (or the set of CTS frames 423 and 424), but the present invention is not limited thereto. According to some embodiments, it is unnecessary to transmit both of the dual RTS frames 411 and 412 (or the dual RTS frames 421 and 422) first. For example, regarding the sub-diagram (a) of FIG. 4, the wireless transceiver device #n (e.g., the AP device 110) may transmit the first RTS frame 411 among the dual RTS frames 411 and 412 and wait for the first CTS frame 413 among the set of CTS frames 413 and 414, and transmit the second RTS frame 412 among the dual RTS frames 411 and 412 and wait for the second CTS frame 414 among the set of CTS frames 413 and 414. In another example, regarding the sub-diagram (b) of FIG. 4, the wireless transceiver device #n (e.g., the AP device 110) may transmit the first RTS frame 421 among the dual RTS frames 421 and 422 and wait for the first CTS frame 423 among the set of CTS frames 423 and 424, and transmit the second RTS frame 422 among the dual RTS frames 421 and 422 and wait for the second CTS frame 424 among the set of CTS frames 423 and 424. Thus, the wireless communication system 100 (or the AP device 110 and the STA device 120) of these embodiments can use the dual RTS frames 411 and 412 (or the dual RTS frames 421 and 422) as well as the set of CTS frames 413 and 414 (or the set of CTS frames 423 and 424) in different RTS/CTS ordering to protect the airtime in the target channel B as well as the non-aligned channel A sequentially, where one of the dual RTS frames 411 and 412 (or the dual RTS frames 421 and 422) is for the non-aligned channel A, and the other one of the dual RTS frames 411 and 412 (or the dual RTS frames 421 and 422) is for the target channel B, but the present invention is not limited thereto. For example, the respective bandwidths of the dual RTS frames 411 and 412 (or the dual RTS frames 421 and 422) as well as the respective bandwidths of the set of CTS frames 413 and 414 (or the set of CTS frames 423 and 424) may vary. For brevity, similar descriptions for these embodiments are not repeated in detail here.

Additionally, no matter whether both of the dual RTS frames 411 and 412 (or the dual RTS frames 421 and 422) are transmitted first, the wireless transceiver device #n (e.g., the AP device 110) can use the dual RTS frames 411 and 412 (or the dual RTS frames 421 and 422) as well as the set of CTS frames 413 and 414 (or the set of CTS frames 423 and 424) to protect the airtime in the target channel B as well as the non-aligned channel A sequentially, but the present invention is not limited thereto. According to some embodiments, both of transmitting the dual RTS frames 411 and 412 and transmitting the dual RTS frames 421 and 422 are unnecessary, and therefore the dual RTS frames 411 and 412 and the dual RTS frames 421 and 422 may be removed from FIG. 4 in these embodiments. For example, regarding the sub-diagram (a) of FIG. 4, the dual control frames may comprise dual CTS frames 413 and 414 sequentially transmitted by the wireless transceiver device #n (e.g., the AP device 110), such as a first CTS frame 413 in the lower BW240 of the target channel B and a second CTS frame 414 in the whole channel bandwidth (e.g., the BW80) of the non-aligned channel A (respectively labeled “240” and “80” for better comprehension). In another example, regarding the sub-diagram (b) of FIG. 4, the dual control frames may comprise dual CTS frames 423 and 424 sequentially transmitted by the wireless transceiver device #n (e.g., the AP device 110), such as a first CTS frame 423 in the whole channel bandwidth (e.g., the BW320) of the target channel B and a second CTS frame 424 in the frequency-shifted channel bandwidth (e.g., the aforementioned another BW320, or “the other BW320”) extending from the whole channel bandwidth (e.g., the BW80) of the non-aligned channel A toward the minimum of the second frequency range of the target channel B (respectively labeled “320” and “320” for better comprehension). Thus, the wireless communication system 100 (or the AP device 110 and the STA device 120) can use the dual CTS frames 413 and 414 (or the dual CTS frames 423 and 424) to protect the airtime in the target channel B as well as the non-aligned channel A sequentially, where one of the dual CTS frames 413 and 414 (or the dual CTS frames 423 and 424) is for the non-aligned channel A, and the other one of the dual CTS frames 413 and 414 (or the dual CTS frames 423 and 424) is for the target channel B, but the present invention is not limited thereto. For example, the respective bandwidths of the dual CTS frames 413 and 414 (or the dual CTS frames 423 and 424) may vary. For brevity, similar descriptions for these embodiments are not repeated in detail here.

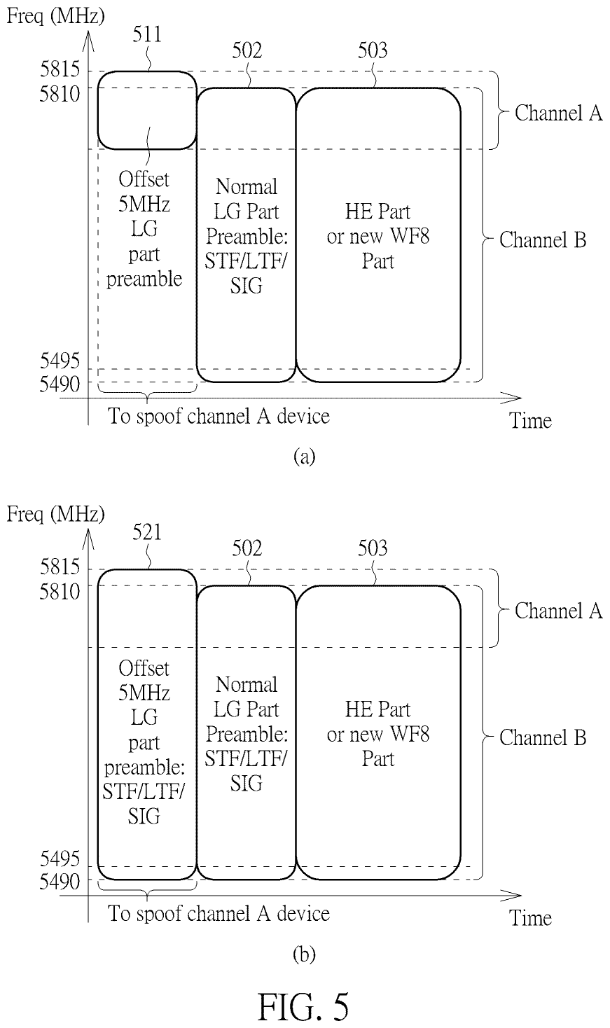

FIG. 5 illustrates, in multiple sub-diagrams (a) and (b) thereof, multiple PPDU modification control schemes of the method according to some embodiments of the present invention. The horizontal axis may represent time, and the vertical axis may represent frequency (labeled “Freq” for brevity) in units of MHz. Assume that one or more functions of the wireless communication system 100 may be temporarily disabled to allow the AP device 110 and the STA device 120 to operate according to a non-modification control scheme regarding the legacy PPDU format, but the present invention is not limited thereto. Based on this non-modification control scheme, the wireless transceiver device #n such as the AP device 110 may be merely using the legacy PPDU format in the target channel B, and therefore the other device (e.g., a Wi-Fi device) that is using the non-aligned channel A cannot correctly receive any PPDU in the target channel B due to the 5 MHz offset. As a result, collision occurs frequently while both of the other device that is using the non-aligned channel A and the AP device 110 and the STA device 120 that are using the target channel B exist.

The wireless communication system 100 (or the AP device 110 and the STA device 120 therein) may operate according to any PPDU modification control scheme among the multiple PPDU modification control schemes to achieve the better overall performance, without being hindered by the other device that is using the non-aligned channel A. Regarding both of the sub-diagrams (a) and (b), in the second case of utilizing the modified PPDU format, the remaining part of the PPDU may comprise a normal preamble 502 corresponding to the target channel B, such as the legacy (LG) preamble including the non-high-throughput (non-HT) short training field (L-STF), the non-HT long training field (L-LTF) and the non-HT SIGNAL field (L-SIG) (labeled “Normal LG Part Preamble: STF/LTF/SIG” for brevity), and further comprise a normal subsequent part 503 corresponding to the target channel B, such as a high efficiency (HE) subsequent part or a new Wi-Fi 8 subsequent part (labeled “HE Part or new WF8 Part” for brevity). For example, the HE subsequent part may comprise the HE preamble, including the repeated non-HT SIGNAL field (RL-SIG), the HE SIGNAL A field (HE-SIG-A), the HE SIGNAL B field (HE-SIG-B), HE-STF and/or one or more HE-LTFs, and comprise the payload of data for the PHY, and the new Wi-Fi 8 subsequent part may comprise the HE preamble and/or a revised version thereof, and comprise the payload of data for the PHY, but the present invention is not limited thereto. In addition, the aforementioned at least one part of the PPDU may comprise an additional preamble at least corresponding to the non-aligned channel A, with the frequency offset for the alignment to the non-aligned channel A. For example, the additional preamble may be implemented as a 5 MHz-offset preamble 511 on the whole channel bandwidth (e.g., the BW80) of the non-aligned channel A, such as the LG preamble including the L-STF, the L-LTF and the L-SIG with the frequency offset of 5 MHz for the alignment to the non-aligned channel A (labeled “Offset 5 MHz LG part preamble” for brevity), in order to spoof the channel A device such as the other device that is using the non-aligned channel A as shown in the sub-diagram (a). In another example, the additional preamble may be implemented as a 5 MHz-offset preamble 521 on the total channel bandwidth (e.g., a 325 MHz bandwidth, or “the BW325”) of the union of the target channel B and the non-aligned channel A, such as the LG preamble including the L-STF, the L-LTF and the L-SIG with the frequency offset of 5 MHz for the alignment to the non-aligned channel A, extending from the whole channel bandwidth (e.g., the BW80) of the non-aligned channel A toward the minimum of the second frequency range of the target channel B (labeled “Offset 5 MHz LG part preamble: STF/LTF/SIG” for brevity), in order to spoof the channel A device such as the other device that is using the non-aligned channel A as shown in the sub-diagram (b).

In the embodiment shown in FIG. 5, the additional preamble may be implemented as the 5 MHz-offset preamble 511 on the whole channel bandwidth (e.g., the BW80) of the non-aligned channel A or the 5 MHz-offset preamble 521 on the total channel bandwidth (e.g., the BW325) of the union of the target channel B and the non-aligned channel A, but the present invention is not limited thereto. According to some embodiments, the bandwidth of the additional preamble may vary, and more particularly, may fall within the range between the whole channel bandwidth (e.g., the BW80) of the non-aligned channel A and the total channel bandwidth (e.g., the BW325) of the union of the target channel B and the non-aligned channel A, such as that of the interval [80, 325] in units of MHz. According to some viewpoints, assuming that the whole channel bandwidth (e.g., the BW80) of the non-aligned channel A may be referred to as the channel A bandwidth BW_A, and that the whole channel bandwidth (e.g., the BW320) of the target channel B may be referred to as the channel B bandwidth BW_B, the total channel bandwidth (e.g., the BW325) of the union of the target channel B and the non-aligned channel A may be regarded as the union (BW_A∪BW_B) of the channel A bandwidth BW_A and the channel B bandwidth BW_B. As a result, the bandwidth of the additional preamble may be greater than or equal to the channel A bandwidth BW_A, such as the BW80, and may be less than or equal to the union (BW_A∪BW_B) of the channel A bandwidth BW_A and the channel B bandwidth BW_B, such as the BW325. For brevity, similar descriptions for these embodiments are not repeated in detail here.

In addition, the remaining part and the aforementioned at least one part of the PPDU in the embodiment shown in FIG. 5 may comprise the normal preamble 502 corresponding to the target channel B and the additional preamble (e.g., the 5 MHz-offset preamble 511 or the 5 MHz-offset preamble 521) at least corresponding to the non-aligned channel A with the frequency offset for the alignment to the non-aligned channel A, respectively, but the present invention is not limited thereto. For example, the preamble 502 may comprise multiple normal basic building blocks respectively corresponding to multiple sub-bandwidths (e.g., multiple 20 MHz bandwidths) within the channel B bandwidth BW_B (e.g., the BW320), and the additional preamble (e.g., the 5 MHz-offset preamble 511 or the 5 MHz-offset preamble 521) may comprise multiple 5 MHz-offset basic building blocks respectively corresponding to multiple sub-bandwidths (e.g., multiple other 20 MHz bandwidths) within the union (BW_A∪BW_B) of the channel A bandwidth BW_A and the channel B bandwidth BW_B, with the frequency offset of 5 MHz for the alignment to the non-aligned channel A, extending from the channel A bandwidth BW_A (e.g., the BW80) toward the minimum frequency of the channel B bandwidth BW_B (e.g., the BW320, or the second frequency range of the target channel B).

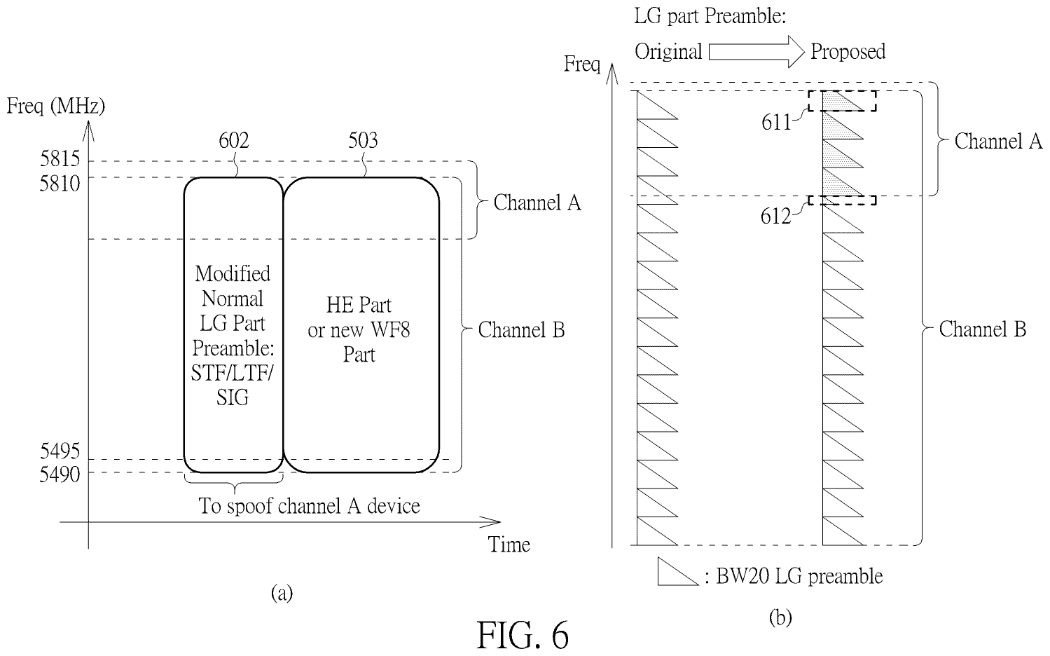

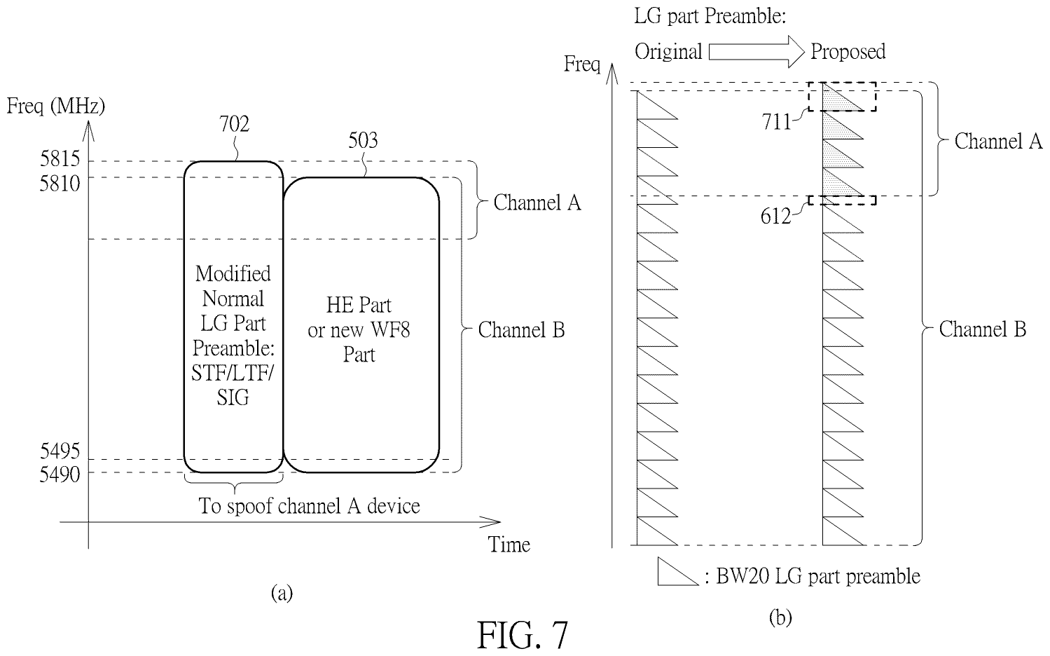

According to some embodiments, the wireless transceiver device #n (e.g., the AP device 110) may modify the normal preamble 502 to make a portion of basic building blocks among the multiple normal basic building blocks be frequency-shifted with the frequency offset of 5 MHz for the alignment to the non-aligned channel A, where it is unnecessary to carry the additional preamble (e.g., the 5 MHz-offset preamble 511 or the 5 MHz-offset preamble 521) as shown in FIG. 5 in the PPDU. More particularly, the remaining part of the PPDU may comprise multiple first basic building blocks of the preamble 502 within the PPDU, and the aforementioned at least one part of the PPDU may comprise multiple second basic building blocks of the preamble 502, with the frequency offset for the alignment to the non-aligned channel A. For example, at least one first basic building block among the multiple first basic building blocks may correspond to a 20 MHz bandwidth (or “BW20”) in the target channel B, and at least one second basic building block among the multiple second basic building blocks may correspond to a 20 MHz bandwidth (or “BW20”) in the non-aligned channel A. The associated implementation details may be described with reference to FIG. 6 and FIG. 7.

FIG. 6 illustrates another PPDU modification control scheme of the method according to an embodiment of the present invention. The horizontal axis and the vertical axis in the sub-diagram (a) may represent time and frequency (labeled “Freq” for brevity) in units of MHz, respectively, and the vertical axis in the sub-diagram (b) may represent frequency. The wireless transceiver device #n (e.g., the AP device 110) may modify the normal preamble 502 to make the aforementioned portion of basic building blocks be frequency-shifted with the frequency offset of 5 MHz for the alignment to the non-aligned channel A, and more particularly, keep the LG part preamble bandwidth (or the bandwidth of the LG part preamble) to be equal to 320 MHz and change the upper 80 MHz tone plan, for example, by shifting 5 MHz upward along the frequency axis, in the LG part preamble to generate the modified preamble 602 (labeled “Modified Normal LG Part Preamble: STF/LTF/SIG” in the sub-diagram (a) for brevity), in order to spoof the channel A device such as the other device that is using the non-aligned channel A.

As shown in the left half part of the sub-diagram (b), the normal preamble 502 such as the original LG part preamble may use the BW20 as a basic building block among the multiple normal basic building blocks of the preamble 502 (labeled “BW20 LG preamble” for brevity) and duplicate it to any other BW20 among all sub-bandwidths {BW20} of the channel B bandwidth BW_B. As shown in the right half part of the sub-diagram (b), another first basic building block 612 among the multiple first basic building blocks (e.g., 13 first basic building blocks corresponding to the lower 245 MHz bandwidth of the whole BW325, for the case that {BW_A, BW_B}={BW80, BW320} and (BW_A∪BW_B)=BW325) may correspond to a bandwidth (e.g., a 5 MHz bandwidth) narrower than the 20 MHz bandwidth in the target channel B, and another second basic building block 611 among the multiple second basic building blocks (e.g., 4 second basic building blocks corresponding to 4 sub-bandwidths within the upper 80 MHz bandwidth of the whole BW325, for the case that {BW_A, BW_B}={BW80, BW320} and (BW_A∪BW_B)=BW325) may correspond to a bandwidth (e.g., a 15 MHz bandwidth) narrower than the 20 MHz bandwidth in the non-aligned channel A. For brevity, similar descriptions for this embodiment are not repeated in detail here.

According to some embodiments, no first basic building block among the multiple first basic building blocks corresponds to any bandwidth narrower than the 20 MHz bandwidth in the target channel B, while the other second basic building block 611 among the multiple second basic building blocks corresponds to the bandwidth narrower than the 20 MHz bandwidth in the non-aligned channel A. More particularly, the wireless transceiver device #n (e.g., the AP device 110) may prepare the multiple first basic building blocks such as the 12 first basic building blocks corresponding to the lower 240 MHz bandwidth of the whole BW325 and keep the 5 MHz gap clear, having no need to prepare the other first basic building block 612 as shown in FIG. 6. For brevity, similar descriptions for these embodiments are not repeated in detail here.

FIG. 7 illustrates another PPDU modification control scheme of the method according to an embodiment of the present invention. The horizontal axis and the vertical axis in the sub-diagram (a) may represent time and frequency (labeled “Freq” for brevity) in units of MHz, respectively, and the vertical axis in the sub-diagram (b) may represent frequency. The wireless transceiver device #n (e.g., the AP device 110) may modify the normal preamble 502 to make the aforementioned portion of basic building blocks be frequency-shifted with the frequency offset of 5 MHz for the alignment to the non-aligned channel A, and more particularly, expand the LG part preamble bandwidth (or the bandwidth of the LG part preamble) to be equal to 325 MHz and change the upper 80 MHz tone plan, for example, by shifting 5 MHz upward along the frequency axis, in the LG part preamble to generate the modified preamble 702 (labeled “Modified Normal LG Part Preamble: STF/LTF/SIG” in the sub-diagram (a) for brevity), in order to spoof the channel A device such as the other device that is using the non-aligned channel A.

As shown in the left half part of the sub-diagram (b), the normal preamble 502 such as the original LG part preamble may use the BW20 as a basic building block among the multiple normal basic building blocks of the preamble 502 (labeled “BW20 LG part preamble” for brevity) and duplicate it to any other BW20 among all sub-bandwidths {BW20} of the channel B bandwidth BW_B. As shown in the right half part of the sub-diagram (b), the other first basic building block 612 among the multiple first basic building blocks (e.g., the 13 first basic building blocks corresponding to the lower 245 MHz bandwidth of the whole BW325, for the case that {BW_A, BW_B}={BW80, BW320} and (BW_A∪BW_B)=BW325) corresponds to the bandwidth (e.g., the 5 MHz bandwidth) narrower than the 20 MHz bandwidth in the target channel B, while no second basic building block among the multiple second basic building blocks (e.g., the 4 second basic building blocks, for the case that {BW_A, BW_B}={BW80, BW320} and (BW_A∪BW_B)=BW325) corresponds to any bandwidth (e.g., the 15 MHz bandwidth) narrower than the 20 MHz bandwidth in the non-aligned channel A, since the second basic building block 711 replaces the other second basic building block 611 shown in FIG. 6. For brevity, similar descriptions for this embodiment are not repeated in detail here.

According to some embodiments, no first basic building block among the multiple first basic building blocks corresponds to any bandwidth narrower than the 20 MHz bandwidth in the target channel B, while no second basic building block among the multiple second basic building blocks corresponds to any bandwidth narrower than the 20 MHz bandwidth in the non-aligned channel A. More particularly, the wireless transceiver device #n (e.g., the AP device 110) may prepare the multiple first basic building blocks such as the 12 first basic building blocks corresponding to the lower 240 MHz bandwidth of the whole BW325 and keep the 5 MHz gap clear, having no need to prepare the other first basic building block 612 as shown in FIG. 7, and prepare the multiple second basic building blocks such as the 4 second basic building blocks corresponding to the upper 80 MHz bandwidth of the whole BW325, without cutting any partial bandwidth of the 20 MHz bandwidth for the second basic building block 711. For brevity, similar descriptions for these embodiments are not repeated in detail here.

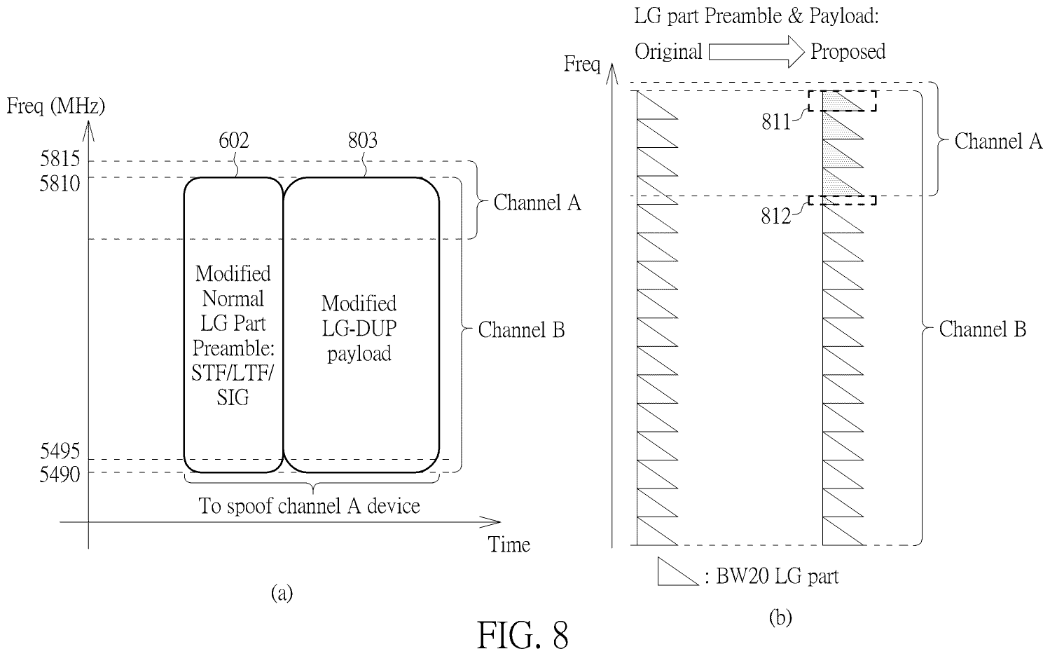

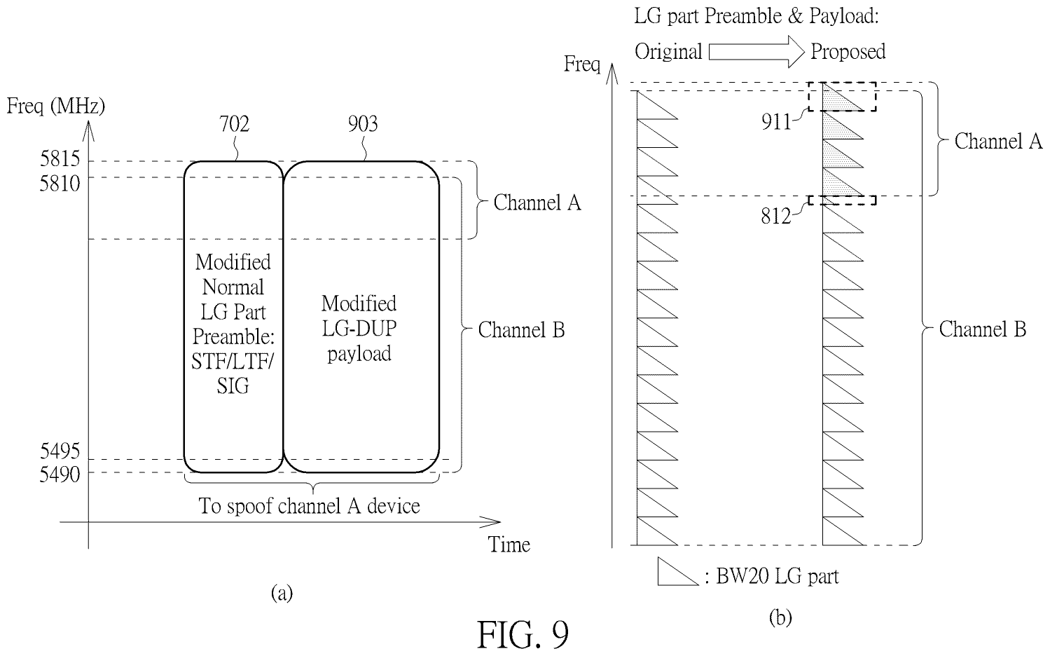

According to some embodiments, assuming that the normal subsequent part 503 may be implemented in accordance with a duplicate PPDU (DUP) mode to comprise multiple DUP payloads respectively corresponding to the multiple sub-bandwidths (e.g., the multiple 20 MHz bandwidths) within the channel B bandwidth BW_B (e.g., the BW320), the wireless transceiver device #n (e.g., the AP device 110) may modify the normal preamble 502 to make the aforementioned portion of basic building blocks among the multiple normal basic building blocks be frequency-shifted with the frequency offset of 5 MHz for the alignment to the non-aligned channel A, and modify the normal subsequent part 503 to make a portion of DUP payloads among the multiple DUP payloads be frequency-shifted with the frequency offset of 5 MHz for the alignment to the non-aligned channel A, where it is unnecessary to carry the additional preamble (e.g., the 5 MHz-offset preamble 511 or the 5 MHz-offset preamble 521) as shown in FIG. 5 in the PPDU. More particularly, the PPDU may be implemented as a duplicate PPDU that carries multiple duplicated payloads of data in multiple sub-bandwidths of the total channel bandwidth (e.g., the BW325) of the union of the target channel B and the non-aligned channel A. In addition, the remaining part of the PPDU may comprise multiple first duplicated payloads among the multiple duplicated payloads, and the aforementioned at least one part of the PPDU may comprise multiple second duplicated payloads among the multiple duplicated payloads, with the frequency offset of 5 MHz for the alignment to the non-aligned channel A. For example, at least one first duplicated payload among the multiple first duplicated payloads may correspond to a 20 MHz bandwidth (or “BW20”) in the target channel B, and at least one second duplicated payload among the multiple second duplicated payloads may correspond to a 20 MHz bandwidth (or “BW20”) in the non-aligned channel A. The associated implementation details may be described with reference to FIG. 8 and FIG. 9.

FIG. 8 illustrates another PPDU modification control scheme of the method according to an embodiment of the present invention. The horizontal axis and the vertical axis in the sub-diagram (a) may represent time and frequency (labeled “Freq” for brevity) in units of MHz, respectively, and the vertical axis in the sub-diagram (b) may represent frequency. The wireless transceiver device #n (e.g., the AP device 110) may modify the normal preamble 502 and the normal subsequent part 503 to make both of the aforementioned portion of basic building blocks within the normal preamble 502 and the aforementioned portion of DUP payloads within the normal subsequent part 503 be frequency-shifted with the frequency offset of 5 MHz for the alignment to the non-aligned channel A, and more particularly, keep the LG-DUP whole packet bandwidth, including both of the LG part preamble bandwidth (or the bandwidth of the LG part preamble) and the DUP payload bandwidth (or the bandwidth of the DUP payloads), to be equal to 320 MHz and change the upper 80 MHz tone plan, for example, by shifting 5 MHz upward along the frequency axis, in the LG-DUP packet to generate the modified preamble 602 and the modified LG-DUP payload(s) 803 (respectively labeled “Modified Normal LG Part Preamble: STF/LTF/SIG” and “Modified LG-DUP payload” in the sub-diagram (a) for brevity), in order to spoof the channel A device such as the other device that is using the non-aligned channel A.

As shown in the left half part of the sub-diagram (b), the wireless transceiver device #n (e.g., the AP device 110) may prepare the normal preamble 502 such as the original LG part preamble by using the BW20 as a basic building block among the multiple normal basic building blocks of the preamble 502 and duplicating it to any other BW20 among all sub-bandwidths {BW20} of the channel B bandwidth BW_B, with the multiple DUP payloads of the normal subsequent part 503 being prepared in these sub-bandwidths {BW20} correspondingly (labeled “BW20 LG part” for brevity). As shown in the right half part of the sub-diagram (b), the first basic building block and duplicated payload set 812, including the other first basic building block 612 shown in FIG. 6 and another first duplicated payload among the multiple first duplicated payloads (e.g., 13 first duplicated payloads corresponding to the lower 245 MHz bandwidth of the whole BW325, for the case that {BW_A, BW_B}={BW80, BW320} and (BW_A∪BW_B)=BW325), may correspond to the bandwidth (e.g., the 5 MHz bandwidth) narrower than the 20 MHz bandwidth in the target channel B, and the second basic building block and duplicated payload set 811, including the other second basic building block 611 shown in FIG. 6 and another second duplicated payload among the multiple second duplicated payloads (e.g., 4 second duplicated payloads corresponding to 4 sub-bandwidths within the upper 80 MHz bandwidth of the whole BW325, for the case that {BW_A, BW_B}={BW80, BW320} and (BW_A∪BW_B)=BW325), may correspond to the bandwidth (e.g., the 15 MHz bandwidth) narrower than the 20 MHz bandwidth in the non-aligned channel A. For brevity, similar descriptions for this embodiment are not repeated in detail here.

According to some embodiments, no first duplicated payload among the multiple first duplicated payloads corresponds to any bandwidth narrower than the 20 MHz bandwidth in the target channel B, while the other second duplicated payload among the multiple second duplicated payloads (e.g., the other second duplicated payload in the second basic building block and duplicated payload set 811) corresponds to the bandwidth narrower than the 20 MHz bandwidth in the non-aligned channel A. More particularly, the wireless transceiver device #n (e.g., the AP device 110) may prepare the multiple first basic building blocks such as the 12 first basic building blocks corresponding to the lower 240 MHz bandwidth of the whole BW325, as well as the multiple first duplicated payloads corresponding to the lower 240 MHz bandwidth of the whole BW325, to generate the first basic building block and duplicated payload sets corresponding to the lower 240 MHz bandwidth of the whole BW325 and keep the 5 MHz gap clear, having no need to prepare the first basic building block and duplicated payload set 812 as shown in FIG. 8. For brevity, similar descriptions for these embodiments are not repeated in detail here.

FIG. 9 illustrates another PPDU modification control scheme of the method according to an embodiment of the present invention. The horizontal axis and the vertical axis in the sub-diagram (a) may represent time and frequency (labeled “Freq” for brevity) in units of MHz, respectively, and the vertical axis in the sub-diagram (b) may represent frequency. The wireless transceiver device #n (e.g., the AP device 110) may modify the normal preamble 502 and the normal subsequent part 503 to make both of the aforementioned portion of basic building blocks within the normal preamble 502 and the aforementioned portion of DUP payloads within the normal subsequent part 503 be frequency-shifted with the frequency offset of 5 MHz for the alignment to the non-aligned channel A, and more particularly, expand the LG-DUP whole packet bandwidth, including both of the LG part preamble bandwidth (or the bandwidth of the LG part preamble) and the DUP payload bandwidth (or the bandwidth of the DUP payloads), to be equal to 325 MHz and change the upper 80 MHz tone plan, for example, by shifting 5 MHz upward along the frequency axis, in LG-DUP packet to generate the modified preamble 702 and the modified LG-DUP payload(s) 903 (respectively labeled “Modified Normal LG Part Preamble: STF/LTF/SIG” and “Modified LG-DUP payload” in the sub-diagram (a) for brevity), in order to spoof the channel A device such as the other device that is using the non-aligned channel A.

As shown in the left half part of the sub-diagram (b), the wireless transceiver device #n (e.g., the AP device 110) may prepare the normal preamble 502 such as the original LG part preamble by using the BW20 as a basic building block among the multiple normal basic building blocks of the preamble 502 and duplicating it to any other BW20 among all sub-bandwidths {BW20} of the channel B bandwidth BW_B, with the multiple DUP payloads of the normal subsequent part 503 being prepared in these sub-bandwidths {BW20} correspondingly (labeled “BW20 LG part” for brevity). As shown in the right half part of the sub-diagram (b), the first basic building block and duplicated payload set 812, including the other first basic building block 612 shown in FIG. 6 and the other first duplicated payload among the multiple first duplicated payloads (e.g., the 13 first duplicated payloads corresponding to the lower 245 MHz bandwidth of the whole BW325, for the case that {BW_A, BW_B}={BW80, BW320} and (BW_A∪BW_B)=BW325), corresponds to the bandwidth (e.g., the 5 MHz bandwidth) narrower than the 20 MHz bandwidth in the target channel B, while no second basic building block and duplicated payload set among all second basic building block and duplicated payload sets corresponds to any bandwidth (e.g., the 15 MHz bandwidth) narrower than the 20 MHz bandwidth in the non-aligned channel A, since the second basic building block and duplicated payload set 911 replaces the second basic building block and duplicated payload set 811, where no second duplicated payload among the multiple second duplicated payloads respectively integrated into these second basic building block and duplicated payload sets corresponds to any bandwidth (e.g., the 15 MHz bandwidth) narrower than the 20 MHz bandwidth in the non-aligned channel A. For brevity, similar descriptions for this embodiment are not repeated in detail here.

According to some embodiments, no first duplicated payload among the multiple first duplicated payloads corresponds to any bandwidth narrower than the 20 MHz bandwidth in the target channel, while no second duplicated payload among the multiple second duplicated payloads corresponds to any bandwidth narrower than the 20 MHz bandwidth in the non-aligned channel A. More particularly, the wireless transceiver device #n (e.g., the AP device 110) may prepare the multiple first basic building blocks such as the 12 first basic building blocks corresponding to the lower 240 MHz bandwidth of the whole BW325, as well as the multiple first duplicated payloads corresponding to the lower 240 MHz bandwidth of the whole BW325, to generate the first basic building block and duplicated payload sets corresponding to the lower 240 MHz bandwidth of the whole BW325 and keep the 5 MHz gap clear, having no need to prepare the first basic building block and duplicated payload set 812 as shown in FIG. 9. In addition, the wireless transceiver device #n (e.g., the AP device 110) may prepare the multiple second basic building blocks such as the 4 second basic building blocks corresponding to the upper 80 MHz bandwidth of the whole BW325, as well as the multiple second duplicated payloads corresponding to the upper 80 MHz bandwidth of the whole BW325, to generate the second basic building blocks and duplicated payload sets corresponding to the upper 80 MHz bandwidth of the whole BW325, without cutting any partial bandwidth of the 20 MHz bandwidth for the second basic building block and duplicated payload set 911. For brevity, similar descriptions for these embodiments are not repeated in detail here.

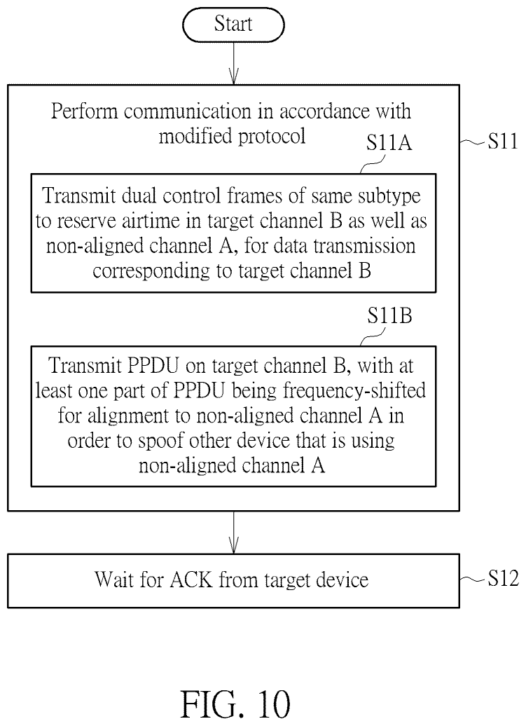

FIG. 10 illustrates a working flow of the method according to an embodiment of the present invention. The wireless transceiver device #n such as the AP device 110 and the target device #n′ such as the STA device 120 may operate according to the working flow shown in FIG. 10, but the present invention is not limited thereto.

In Step S11, the wireless transceiver device #n such as the AP device 110 (or the communication control circuit 114) may perform communication in accordance with modified protocol. For example, the wireless transceiver device #n such as the AP device 110 may perform the operation of Step S11A in the first case of utilizing the modified procedure, or perform the operation of Step S11B in the second case of utilizing the modified PPDU format.

In Step S11A, the wireless transceiver device #n such as the AP device 110 (or the communication control circuit 114) may transmit the dual control frames of the same subtype to reserve the airtime in the target channel B as well as the non-aligned channel A, for the data transmission corresponding to the target channel B, where one of the dual control frames is sent via the target channel B while the other of the dual control frames is sent via the non-aligned channel A. More particularly, after reserving the airtime in the target channel B as well as the non-aligned channel A, the wireless transceiver device #n such as the AP device 110 may perform the data transmission corresponding to the target channel B in order to send the data via the target channel B.

In Step S11B, the wireless transceiver device #n such as the AP device 110 (or the communication control circuit 114) may transmit the PPDU on the target channel B, with the aforementioned at least one part of the PPDU being frequency-shifted for alignment to the non-aligned channel A in order to spoof the other device that is using the non-aligned channel A, where the remaining part of the PPDU is sent via the target channel B while the aforementioned at least one part of the PPDU is sent via the non-aligned channel A.

In Step S12, the wireless transceiver device #n such as the AP device 110 (or the communication control circuit 114) may wait for the ACK from the target device #n′, such as the ACK that is sent by the target device #n′ (e.g., the STA device 120) in response to the reception of the data.

For better comprehension, the method may be illustrated with the working flow shown in FIG. 10, but the present invention is not limited thereto. According to some embodiments, one or more steps may be added, deleted, or changed in the working flow shown in FIG. 10.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing coexistence management with respect to a non-aligned channel in a wireless communication system, wherein a target device using a target channel is wirelessly linking to a wireless transceiver device, and a difference between a minimum of a first frequency range of the non-aligned channel and a minimum of a second frequency range of the target channel is not a multiple of twenty megahertz (20 MHz), the method comprising:
transmitting, by the wireless transceiver device, dual control frames of a same subtype to reserve airtime in the target channel as well as the non-aligned channel, for data transmission corresponding to the target channel;
wherein one of the dual control frames is sent via the target channel while the other of the dual control frames is sent via the non-aligned channel.

2. The method of claim 1, wherein the dual control frames comprises dual request to send (RTS) frames concurrently transmitted by the wireless transceiver device.

3. The method of claim 2, wherein the wireless transceiver device is arranged to concurrently transmit the dual RTS frames to reserve the airtime in the target channel as well as the non-aligned channel, and wait for a set of clear to send (CTS) frames corresponding to the dual RTS frames, the set of CTS frames from the target device, for performing the data transmission corresponding to the target channel afterward.

4. The method of claim 1, wherein the dual control frames comprises dual clear to send (CTS) frames concurrently transmitted by the wireless transceiver device.

5. The method of claim 1, wherein the dual control frames comprises dual request to send (RTS) frames sequentially transmitted by the wireless transceiver device.

6. The method of claim 5, wherein the wireless transceiver device is arranged to sequentially transmit the dual RTS frames to reserve the airtime in the target channel as well as the non-aligned channel, and wait for a set of clear to send (CTS) frames corresponding to the dual RTS frames, the set of CTS frames from the target device, for performing the data transmission corresponding to the target channel afterward.

7. The method of claim 6, wherein the wireless transceiver device is arranged to transmit both of the dual RTS frames first, and then wait for the set of CTS frames.

8. The method of claim 6, wherein the wireless transceiver device is arranged to transmit a first RTS frame among the dual RTS frames and wait for a first CTS frame among the set of CTS frames, and transmit a second RTS frame among the dual RTS frames and wait for a second CTS frame among the set of CTS frames.

9. The method of claim 1, wherein the dual control frames comprises dual clear to send (CTS) frames sequentially transmitted by the wireless transceiver device.

10. The method of claim 1, wherein the target channel is configured in at least two unlicensed national information infrastructure (UNII) radio bands, and the non-aligned channel is configured in one of the at least two UNII radio bands to have a non-20 MHz-based channel offset, which is not any offset of any multiple of 20 MHz, with respect to any neighbor channel in the other of the at least two UNII radio bands.

11. The method of claim 10, wherein the non-20 MHz-based channel offset represents a five megahertz (5 MHz) channel offset.

12. The method of claim 1, wherein multiple unlicensed national information infrastructure (UNII) radio bands comprise a UNII-2C band and a UNII-3 band; and the target channel is configured to extend from the UNII-2C band to the UNII-3 band, and the non-aligned channel is configured in the UNII-3 band.

13. The method of claim 12, wherein the non-aligned channel is one of two neighbor channels, having a predetermined gap therebetween, respectively belonging to the UNII-2C band and the UNII-3 band.

14. The method of claim 13, wherein the predetermined gap is not equal to any multiple of 20 MHz.

15. The method of claim 1, wherein the wireless transceiver device is arranged to carry at least one medium access control (MAC) address among a first MAC address of the wireless transceiver device and a second MAC address of the target device in each control frame among the dual control frames.

16. A wireless transceiver device, for performing coexistence management with respect to a non-aligned channel in a wireless communication system, the wireless transceiver device comprising:
a processing circuit, arranged to control operations of the wireless transceiver device; and
at least one communication control circuit, coupled to the processing circuit, arranged to perform communication control, wherein the at least one communication control circuit is arranged to perform wireless communication operations with at least one other device within the wireless communication system for the wireless transceiver device, wherein a target device using a target channel among the at least one other device is wirelessly linking to the wireless transceiver device, and a difference between a minimum of a first frequency range of the non-aligned channel and a minimum of a second frequency range of the target channel is not a multiple of twenty megahertz (20 MHz);
wherein:
the wireless transceiver device is arranged to transmit dual control frames of a same subtype to reserve airtime in the target channel as well as the non-aligned channel, for data transmission corresponding to the target channel; and
one of the dual control frames is sent via the target channel while the other of the dual control frames is sent via the non-aligned channel.

17. A method for performing coexistence management with respect to a non-aligned channel in a wireless communication system, wherein a target device using a target channel is wirelessly linking to a wireless transceiver device, and a difference between a minimum of a first frequency range of the non-aligned channel and a minimum of a second frequency range of the target channel is not a multiple of twenty megahertz (20 MHz), the method comprising:
transmitting, by the wireless transceiver device, a physical layer (PHY) protocol data unit (PPDU) on the target channel, with at least one part of the PPDU being frequency-shifted for alignment to the non-aligned channel in order to spoof another device that is using the non-aligned channel;
wherein a remaining part of the PPDU is sent via the target channel while the at least one part of the PPDU is sent via the non-aligned channel.

18. The method of claim 17, wherein the remaining part of the PPDU comprises a normal preamble corresponding to the target channel, and the at least one part of the PPDU comprises an additional preamble at least corresponding to the non-aligned channel, with a frequency offset for the alignment to the non-aligned channel.

19. The method of claim 17, wherein the remaining part of the PPDU comprises multiple first basic building blocks of a preamble within the PPDU, and the at least one part of the PPDU comprises multiple second basic building blocks of the preamble, with a frequency offset for the alignment to the non-aligned channel.

20. The method of claim 19, wherein at least one first basic building block among the multiple first basic building blocks corresponds to a 20 MHz bandwidth in the target channel, and at least one second basic building block among the multiple second basic building blocks corresponds to a 20 MHz bandwidth in the non-aligned channel.

21. The method of claim 20, wherein another first basic building block among the multiple first basic building blocks corresponds to a bandwidth narrower than the 20 MHz bandwidth in the target channel, and another second basic building block among the multiple second basic building blocks corresponds to a bandwidth narrower than the 20 MHz bandwidth in the non-aligned channel.

22. The method of claim 20, wherein no first basic building block among the multiple first basic building blocks corresponds to any bandwidth narrower than the 20 MHz bandwidth in the target channel, and another second basic building block among the multiple second basic building blocks corresponds to a bandwidth narrower than the 20 MHz bandwidth in the non-aligned channel.

23. The method of claim 20, wherein another first basic building block among the multiple first basic building blocks corresponds to a bandwidth narrower than the 20 MHz bandwidth in the target channel, and no second basic building block among the multiple second basic building blocks corresponds to any bandwidth narrower than the 20 MHz bandwidth in the non-aligned channel.

24. The method of claim 20, wherein no first basic building block among the multiple first basic building blocks corresponds to any bandwidth narrower than the 20 MHz bandwidth in the target channel, and no second basic building block among the multiple second basic building blocks corresponds to any bandwidth narrower than the 20 MHz bandwidth in the non-aligned channel.

25. The method of claim 17, wherein the PPDU is a duplicate PPDU that carries multiple duplicated payloads of data in multiple sub-bandwidths of a total channel bandwidth of a union of the target channel and the non-aligned channel; and the remaining part of the PPDU comprises multiple first duplicated payloads among the multiple duplicated payloads, and the at least one part of the PPDU comprises multiple second duplicated payloads among the multiple duplicated payloads, with a frequency offset for the alignment to the non-aligned channel.

26. The method of claim 25, wherein at least one first duplicated payload among the multiple first duplicated payloads corresponds to a 20 MHz bandwidth in the target channel, and at least one second duplicated payload among the multiple second duplicated payloads corresponds to a 20 MHz bandwidth in the non-aligned channel.

27. The method of claim 26, wherein another first duplicated payload among the multiple first duplicated payloads corresponds to a bandwidth narrower than the 20 MHz bandwidth in the target channel, and another second duplicated payload among the multiple second duplicated payloads corresponds to a bandwidth narrower than the 20 MHz bandwidth in the non-aligned channel.

28. The method of claim 26, wherein no first duplicated payload among the multiple first duplicated payloads corresponds to any bandwidth narrower than the 20 MHz bandwidth in the target channel, and another second duplicated payload among the multiple second duplicated payloads corresponds to a bandwidth narrower than the 20 MHz bandwidth in the non-aligned channel.

29. The method of claim 26, wherein another first duplicated payload among the multiple first duplicated payloads corresponds to a bandwidth narrower than the 20 MHz bandwidth in the target channel, and no second duplicated payload among the multiple second duplicated payloads corresponds to any bandwidth narrower than the 20 MHz bandwidth in the non-aligned channel.

30. The method of claim 26, wherein no first duplicated payload among the multiple first duplicated payloads corresponds to any bandwidth narrower than the 20 MHz bandwidth in the target channel, and no second duplicated payload among the multiple second duplicated payloads corresponds to any bandwidth narrower than the 20 MHz bandwidth in the non-aligned channel.

31. A wireless transceiver device, for performing coexistence management with respect to a non-aligned channel in a wireless communication system, the wireless transceiver device comprising:
a processing circuit, arranged to control operations of the wireless transceiver device; and
at least one communication control circuit, coupled to the processing circuit, arranged to perform communication control, wherein the at least one communication control circuit is arranged to perform wireless communication operations with at least one other device within the wireless communication system for the wireless transceiver device, wherein a target device using a target channel among the at least one other device is wirelessly linking to the wireless transceiver device, and a difference between a minimum of a first frequency range of the non-aligned channel and a minimum of a second frequency range of the target channel is not a multiple of twenty megahertz (20 MHz);
wherein:
the wireless transceiver device is arranged to transmit a physical layer (PHY) protocol data unit (PPDU) on the target channel, with at least one part of the PPDU being frequency-shifted for alignment to the non-aligned channel in order to spoof another device that is using the non-aligned channel; and
a remaining part of the PPDU is sent via the target channel while the at least one part of the PPDU is sent via the non-aligned channel.
